(19) United States
(12) Patent Application Publication
(10) Pub. No.: US 2025/0027728 A1
(43) Pub. Date: Jan. 23, 2025

(54) CORRUGATED GRID MAT

(71) Applicant: Hewitech GmbH & Co. KG, Ochtrup (DE)

(72) Inventor: Frank DIRKSKÖTTER, Ochtrup (DE)

(21) Appl. No.: 18/775,385

(22) Filed: Jul. 17, 2024

(30) Foreign Application Priority Data
Jul. 19, 2023 (DE) 10 2023 119 121.7

(51) Int. Cl. F28F 3/02; B32B 3/28

(52) U.S. Cl. CPC F28F 3/025; B32B 3/28

(57) ABSTRACT

The grid mat (12) is provided with an upper and an underside (25, 26), two longitudinal edges (22, 23) connecting these and transverse edges (24) and alternately adjacent depressions (16) and elevations (14) extending in a straight line at an angle to the longitudinal and transverse edges. A rectilinear first grid strut (18) extends along each of the elevations (14) of the depressions (16). Adjacent first grid struts (18) are connected by intersecting second and third grid struts (27, 28). Each first grid strut (18) extending up to the first longitudinal edge (22) has a first interruption section (42), which has a first distance (L1) from the first longitudinal edge (22), while each first grid strut (18) extending up to the second longitudinal edge (23) has a second interruption section (44), which has a second distance (L2) from the second longitudinal edge (23). In one embodiment, the second distance (L1) is less than the first distance (L2). The first grid struts (18) of two respective adjacent elevations (14) and/or two respective adjacent depressions (16) are respectively connected on both sides of their first and second interruption sections (42, 44) by further grid struts (48 to 62) forming sub-networks (46) with one another, which sub-networks (46) being interconnected by fourth grid struts (72) respectively extending parallel to the longitudinal edges (22, 23).

The present application claims priority of the German patent application 10 2023 119 121.7 filed on Jul. 19, 2023, the content thereof is herewith incorporated by reference and belongs to the disclosure of the present application.

The invention relates to a corrugated grid mat made of plastic material, in particular thermoplastic plastic material, of an installation element, comprising a stack of a plurality of such grid mats, of a device for treating a useful fluid by means of a working fluid, in particular for humidifying and/or cleaning and/or cooling a useful fluid, in particular a gas, by means of a working fluid, in particular sprayed water.

Devices for treating gases, in particular for humidifying, cleaning and/or cooling gases such as air, are generally known. Such devices can be used, for example, as evaporative humidifiers or material exchangers, which are used, among other things, for air humidification and simultaneous air cooling, e.g. in residential or office buildings, warehouses, stables, greenhouses and other rooms or also in technical systems, e.g. for cleaning and in particular dedusting supply or exhaust air for reactive gas or air purification (in particular removal of odorous substances such as ammonia from stable air). The cooling of a gas with the aid of such devices is based on the principle of adiabatic cooling (evaporative cooling). However, treatment devices are also used in particular as heat exchangers, e.g. for installation in or on cooling towers, and are generally known in the design of trickle coolers.

A cooler comprising a support for grid or foil packages carried on individual beams is disclosed in WO-A-2018/144857. U.S. Pat. No. 3,216,165 and DE-T-69319761 both relate to floor constructions with beams carrying individual floor plates.

The known treatment devices of the above-mentioned types have installation devices in the form of installation packages, each of which has a plurality of grid mats, which are usually corrugated, so that when adjacent grid mats are in close contact, intersecting or laterally offset channels are formed through which the gas flows in via an inlet side of the device, flows through the device and flows out again at an opposite outlet side. Examples of such grid mats and installation packages formed from them are described in WO-A-2009/153278, WO-A-2015/044274, EP-A-0 825 407 and DE-U-67 51 260.

The inlet and outlet sides of the device or installation packs are formed by the opposite edges of individual adjacent grid mats of the installation packs arranged on the inlet and outlet sides of the device. The fluid to be treated therefore flows parallel to the extension of the grid mats between their respective edges and between the grid mats. In principle, however, it is also possible for the fluid to be treated to flow transverse to the extent of the grid mats.

The installation packages of the above-mentioned types of useful fluid treatment devices are wetted with liquid, the so-called working fluid, which is in particular water, so that the useful fluid to be treated flows along wetted surfaces of the grid mats. It is desirable for the wetting liquid to form as large a surface as possible and to remain in the device or installation packages for a longer period of time.

As a rule, the grid mats are rectangular, with several adjacent grid mats forming a block-shaped (cuboid) installation package. However, it is also possible that the installation packages have other geometric shapes. For example, a cylindrical installation package could be created by using rectangular grid mats of different sizes. The widest grid mats are then arranged along a diameter of the cross-section of the cylinder, with the respective adjacent grid mats decreasing in width.

The known useful fluid treatment devices can operate according to the counterflow or cross-flow principle. With the counterflow principle, the fluid to be treated and the working fluid (e.g. cooling medium) used to treat this fluid flow in opposite directions. In treatment devices that work according to the cross-flow principle, the flow directions of the fluid to be treated and the working fluid cross each other, usually at an essentially right angle.

As already described above, the grid mats of the installation elements are made of plastic, in particular thermoplastic plastic, and are manufactured by injection molding. It is advantageous for the efficiency and effectiveness of the treatment of the useful fluid by the working fluid if the channels formed by the grid structure of the individual grid mats intersect with adjacent grid mats. This is advantageously achieved by the corrugated grid mat having rectilinear elevations and depressions, i.e. “crests” and “troughs”, so to speak, which are connected by grid-shaped grid struts and which extend at an angle of unequal 90°, i.e. obliquely, to the longitudinal and transverse edges of the grid mat. However, this results in a non-symmetrically structured grid mat. If the hot plastic material introduced into the injection mold cools down after the injection mold has been opened, the grid mats become warped due to shrinkage in the longitudinal and transverse directions, which is why they are no longer rectangular but parallelogram-shaped.

This phenomenon can be counteracted, for example, by interrupting some of the plastic grid struts of the grid mat to create irregularities therein. This concept is pursued in EP-A-2 881 170 and DE-A-10 2005 051 882.

However, if the interruptions in some of the grid struts are distributed across the grid mat in a way that is not optimal for the mechanical stability of the installation element, this can again lead to problems.

It is an object of the invention is to provide corrugated grid mats of an installation element comprising a stack of several such grid mats, which give the installation element sufficient stability when assembled as a stack.

The invention relates to a corrugated grid mat made of plastic material, in particular thermoplastic plastic material, of an installation element, comprising a stack of a plurality of such grid mats, of a device for treating a useful fluid by means of a working fluid, in particular for humidifying and/or cleaning and/or cooling a useful fluid, in particular a gas, by means of a working fluid, in particular sprayed water.
an upper side and a lower side,
a first longitudinal edge and a second longitudinal edge which extend essentially parallel to each other and are connected by two transverse edges which extend transversely to these longitudinal edges and are also essentially parallel to each other,
alternately adjacent depressions and elevations extending in a straight line at an angle not equal to 90° to both the longitudinal edges and the transverse edges with slopes connecting them,
wherein the elevations are arranged on the upper side and the recesses on the lower side,
wherein a straight first grid strut extends along the elevations on the upper side and along the depressions on the lower side,
wherein the first grid struts of a respective elevation and the depression adjacent thereto are connected by intersecting second and third grid struts which extend along the slopes and form first intersection points with one another and second intersection points with the first grid struts on the upper side and on the lower side respectively,
wherein each first grid strut extending to the first longitudinal edge has a first interruption section, the center point of which is at a first distance from the first longitudinal edge,
wherein each first grid strut extending to the second longitudinal edge has a second interruption section which is at a second distance from the second longitudinal edge,
wherein the first distance is smaller than the second distance,
wherein the first grid struts of each of two adjacent elevations and/or each of two adjacent depressions are connected on both sides of their first and second interruption sections by further grid struts forming sub-networks with one another, and
wherein the sub-networks arranged next to one another along one of the longitudinal edges in each case are connected to one another by a fourth grid strut extending longitudinally to the respective longitudinal edge, which extends through the first or second interruption section and, for example, extends through the first or second interruption section at the midpoint thereof and which can extend in a straight line or in a zig-zag shape.

According to the invention, the grid mat has an upper side and a lower side as known per se. The grid mat is bounded by a first longitudinal edge and a second longitudinal edge as well as two transverse edges that connect the two longitudinal edges. Both the longitudinal edges and the transverse edges are essentially parallel to each other. Alternately adjacent depressions and elevations with slopes connecting them extend in a straight line at an angle not equal to 90° to both the longitudinal edges and the transverse edges. The entire grid mat has grid struts. The first grid struts extend along the elevations on the upper side of the grid mat and along the indentations on the lower side of the grid mat. Adjacent first grid struts, i.e. the first grid strut of an elevation and the first grid strut of the adjacent depression are connected by intersecting second and third grid struts, which form first intersection points on the slopes and, together with said first grid struts, form second intersection points, which are accordingly located on the upper side and on the lower side of the grid mat.

According to the invention, it is further provided that each first grid strut extending towards the first longitudinal edge has a first interruption section which is at a first distance from the first longitudinal edge. The first grid struts are therefore interrupted in their extension towards the first longitudinal edge. In accordance with the invention, the first grid struts are also interrupted in their extension in the direction of the second longitudinal edge. The particularity is that the two interruption sections have different distances to the respective longitudinal edges. The first distance is smaller than the second distance. To connect the first grid struts to the respective longitudinal edge sections of the grid mat, it is provided that the first grid struts of two adjacent elevations and/or two adjacent depressions are each connected on both sides of their first and second interruption sections by further grid struts forming sub-networks with each other, these sub-networks being connected to each other by straight fourth grid struts extending parallel to the longitudinal edges.

The different distances between the first interruption sections and the first longitudinal edge and between the second interruption sections and the second longitudinal edge ensure a sufficient irregularity of the grid structure of the grid mat, which counteracts the distortion of the typically rectangular grid mat during cooling and largely prevents such distortion. If two grid mats according to the invention are now placed on top of each other so that their oblique elevations and depressions intersect, intersecting channels are formed on the one hand and first and second interruption sections offset from each other at the longitudinal edges on the other hand, so that it is prevented that when several grid mats are assembled in this way to form an installation package, no mutually aligned first and second interruption sections are formed at the opposite longitudinal edges of the installation package, which are defined by the longitudinal edges of the individual grid mats, but that first and second interruption sections alternately follow one another. This in turn increases the stability of the installation package. If these installation packages are now laid out next to each other in vertical alignment of their grid mats in order to place a first layer of such grid mats in a cooling tower, for example, this first layer of grid mats can be walked on in order to arrange a second layer of installation packages thereon. The installation packages are sufficiently stable to mechanically withstand the weight of a person walking on the installation package layer.

The two fourth grid struts, which extend continuously and parallel to the two longitudinal edges at different distances therefrom, also compensate for uneven, asymmetrical distortion of the grid mat during cooling, so that the grid mat remains essentially rectangular. The channels of the injection mold correspond to the fourth grid struts of the grid mat (as is also the case for all other grid struts of the grid mat). Through each of the channels of the injection mold corresponding to the fourth grid struts, liquid material passes quite quickly into the intersecting and/or otherwise interconnected channels for the grid struts of the sub-networks when the plastic is introduced into the injection mold, which simplifies and improves the “filling” of the injection mold with material and shortens the time required, which are further advantages associated with the invention.

In an advantageous embodiment of the invention, it may further be provided that the first and second interruption sections are of equal width. Alternatively, it is therefore also possible for the interruption sections to have different lengths. The dimensions of the interruption sections and their distances to the respective longitudinal edges can be selected so that the interruption sections of two grid mats lying next to each other in the above manner with crossed elevations and depressions overlap or are completely offset from each other.

In an expedient embodiment of the invention, it is further provided that the sub-networks each have a central section located at a height between the upper side and the lower side and that the fourth grid struts also extend at this height. The sub-networks, which connect adjacent elevations or adjacent depressions within the interruption sections, are suitably located in the area between the upper side and the lower side of the grid mat and advantageously “midway” between the upper side and the lower side of the grid mat.

In a further advantageous embodiment of the invention, it is expedient if the first grid struts each have laterally projecting rod-shaped projections between the second intersection points with the second and third grid struts, which projections extend at the level of the upper side and the lower side respectively, it also being advantageous if two rod-shaped projections extending together in a V-shape are arranged on each side of a first grid strut, these four rod-shaped projections in turn extending in an X-shape. These designs with rod-shaped protruding protrusions have the advantage that the surface area of the grid mat is increased, which in turn means that the working fluid has a larger surface area to “cling to” in order to form a larger surface area, which in turn is advantageous for the interaction with the working fluid.

Furthermore, in an advantageous embodiment of the invention, it is provided that at least two of the grid struts of each sub-network cross each other and that the fourth grid strut extends through this intersection point.

Typically, in an advantageous embodiment of the invention, it is further provided that the fourth grid struts cross some of the grid struts of each sub-network.

Finally, in a further advantageous embodiment of the invention, it may be provided that adjacent sub-networks are connected by some of their grid struts to the adjacent first grid struts and in particular to the first grid struts of adjacent elevations or adjacent depressions.

Overall, it can be said that grid mats have generally proven themselves in practice compared to foil elements, due to the low flow resistance of a grid mat installation package compared to a foil mat installation package. The low flow resistance is achieved at the expense of a more “airy” design of the individual mats, which are designed as a grid structure. However, this reduces the surface area which the working fluid can “cling to”. This in turn can be counteracted to a certain extent by designing projections that protrude from the grid struts, namely from all the grid struts.

As already mentioned above, the grid mats according to the invention are assembled alternately, one inside the other, to form installation packages. It is generally known to provide pin-hole formations on the upper and lower side of a grid mat to connect the grid mats assembled in this way to form an installation package. In this context, an advantageous embodiment of the invention provides for the grid mat to have pin formations and hole formations which are distributed over the upper side and the lower side and which are complementary to one another for connecting grid mats of the grid mat stack of an installation element which are arranged one above the other with the elevations and depressions of adjacent grid mats of the grid mat stack intersecting, by arranging adjacent grid mats of the grid mat stack alternately with their upper sides and with their lower sides adjacent to one another, the first and the second interruption sections of a grid mat being arranged laterally offset with respect to their longitudinal edges relative to the second and first interruption sections of the respectively adjacent grid mat. Examples of possible pin-hole designs are described in EP 3 690 378 A1 and DE 197 33 480 A1.

It is expedient if the distance of the end of the second interruption section facing the second longitudinal edge from the second longitudinal edge is greater than the distance of the end of the first interruption section facing away from the first longitudinal edge from the first longitudinal edge by more than the width of the first interruption section, so that when two grid mats are placed on top of each other, sections of the grid struts extending to the second longitudinal edge extend over the first interruption sections with their upper sides in contact or with their lower sides in contact.

In a further advantageous embodiment of the invention, it can be provided that between the second interruption sections and the second longitudinal edge in the direction orthogonal to the second longitudinal edge, spaced-apart pin and/or hole formations are provided which, with respect to their respective spacing, correspond with pin and/or hole formations which are arranged on both sides of the first interruption section, so that, when two grid mats are placed one on top of the other with their upper sides in contact or with their lower sides in contact, sections of the grid struts extending to the second longitudinal edge extend over the first interruption sections and the two grid mats are mechanically connected to one another by the complementary pin and/or hole formations within the sections in which grid struts extend over the first interruption sections and over the second interruption sections.

The above-mentioned object is further achieved according to the invention by an installation element of a device for treating a useful fluid by means of a working fluid, in particular for humidifying and/or cleaning and/or cooling a useful fluid, in particular a gas, by means of a working fluid, in particular sprayed water, the installation element being provided with
a stack of adjoining corrugated grid mats according to the invention and/or according to one of the previously described embodiments of the invention,
wherein adjacent grid mats lie against one another with intersecting elevations and depressions, by arranging respective adjacent grid mats alternately with their upper sides and their lower sides lying against one another, and by arranging the first and second interruption sections of a grid mat laterally offset with respect to the second and first interruption sections of the respectively adjacent grid mat.

The invention is described in more detail below by means of an exemplary embodiment and with reference to the drawing. In detail, the Figures show:

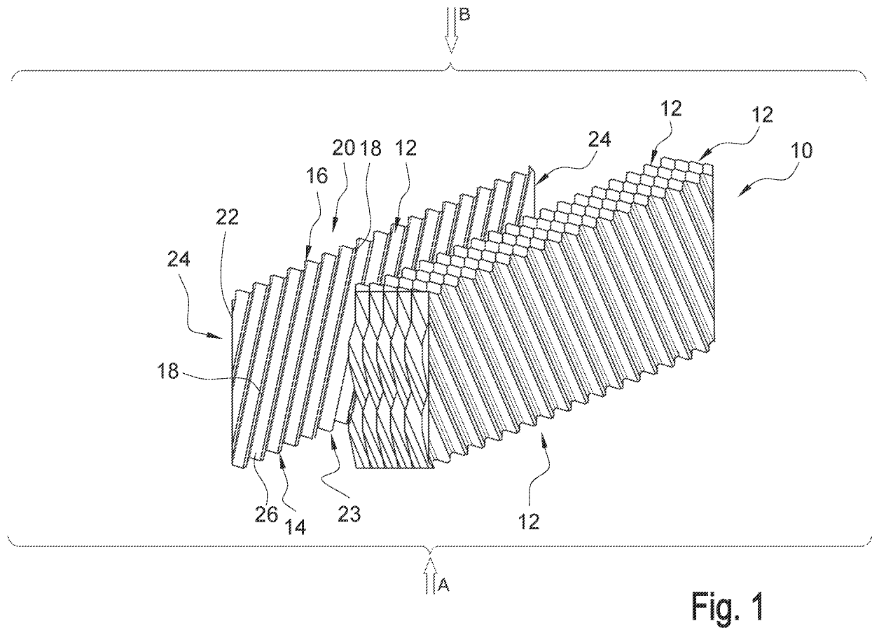

FIG. 1 a schematic representation of an installation element, which is composed of a plurality of diagonally corrugated grid mats with alternately crossing corrugations (elevations and depressions), whereby the installation element is shown in its installation situation with vertically aligned grid mats, but without showing the grid structure of the grid mats in this representation,

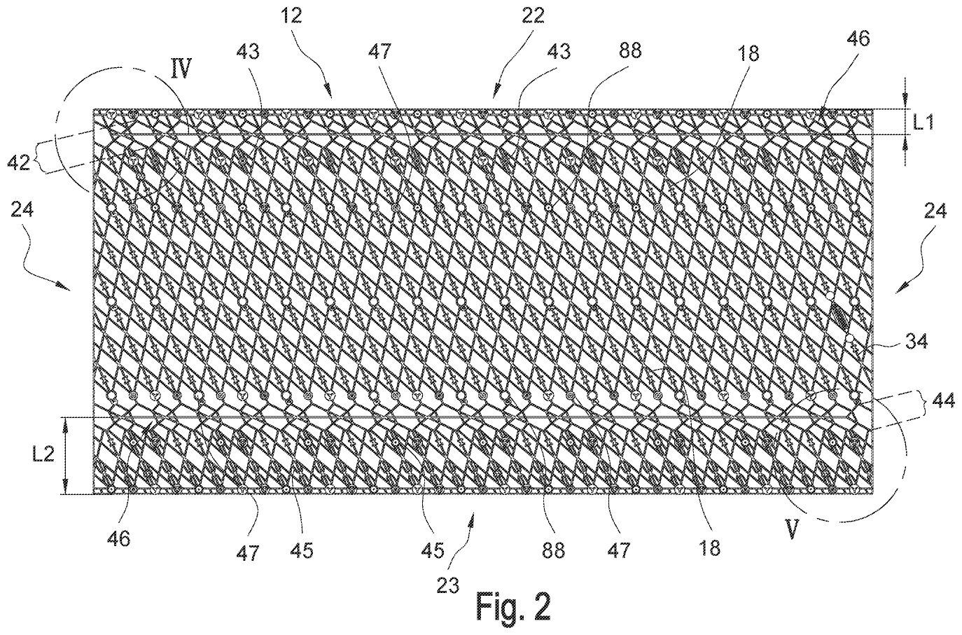

FIG. 2 a top plan view of a grid mat with first grid struts interrupted in the area of their longitudinal edges on the upper and lower sides, whereby the interruption sections have different distances to the longitudinal edges,

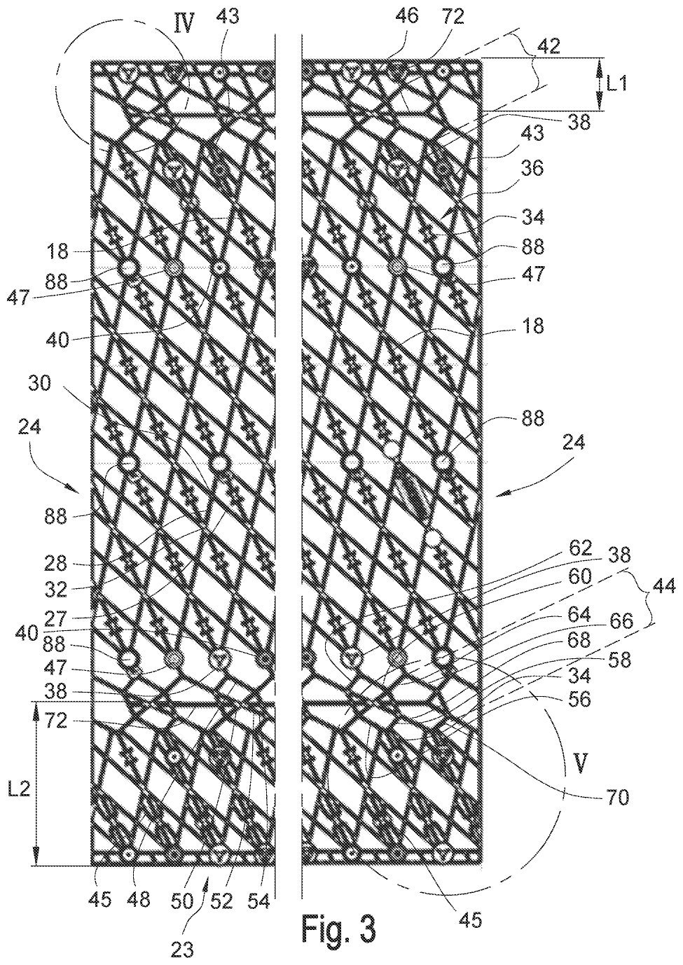

FIG. 3 an enlarged top plan view of the grid mat, in which only the two opposite transverse edge end areas are shown,

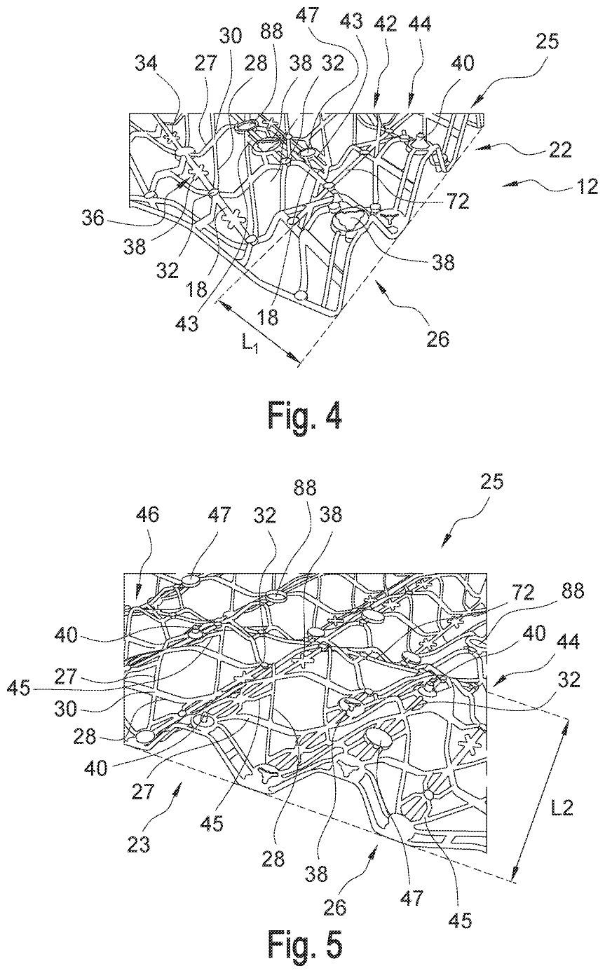

FIG. 4 a perspective view of the area shown in FIGS. 2 and 3 at IV,

FIG. 5 a perspective view of the area shown in FIGS. 2 and 3 at V,

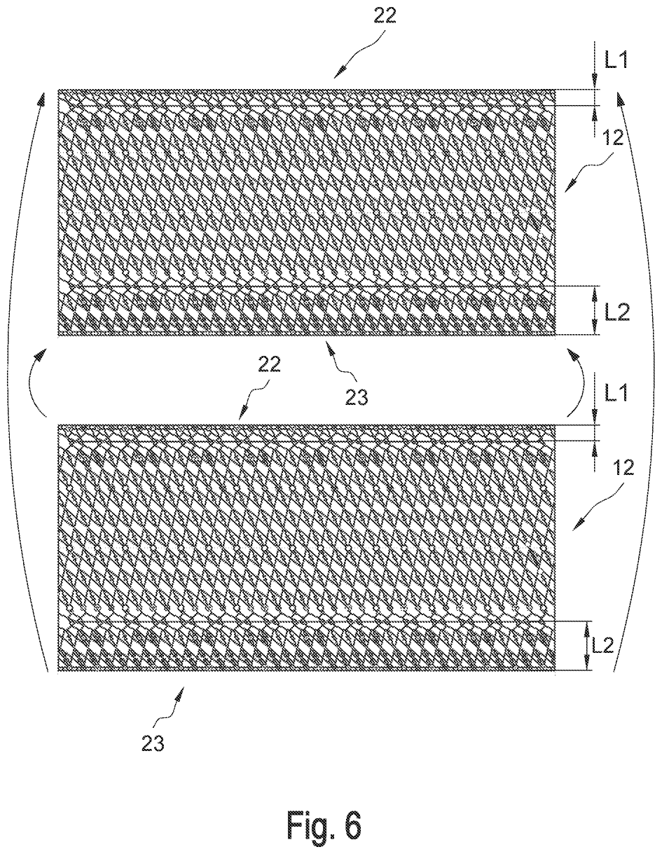

FIG. 6 schematically illustrates how two adjacent grid mats are laid on upper of each other to form intersecting flow half-channels and stabilize the grid mats within their interruption sections, and

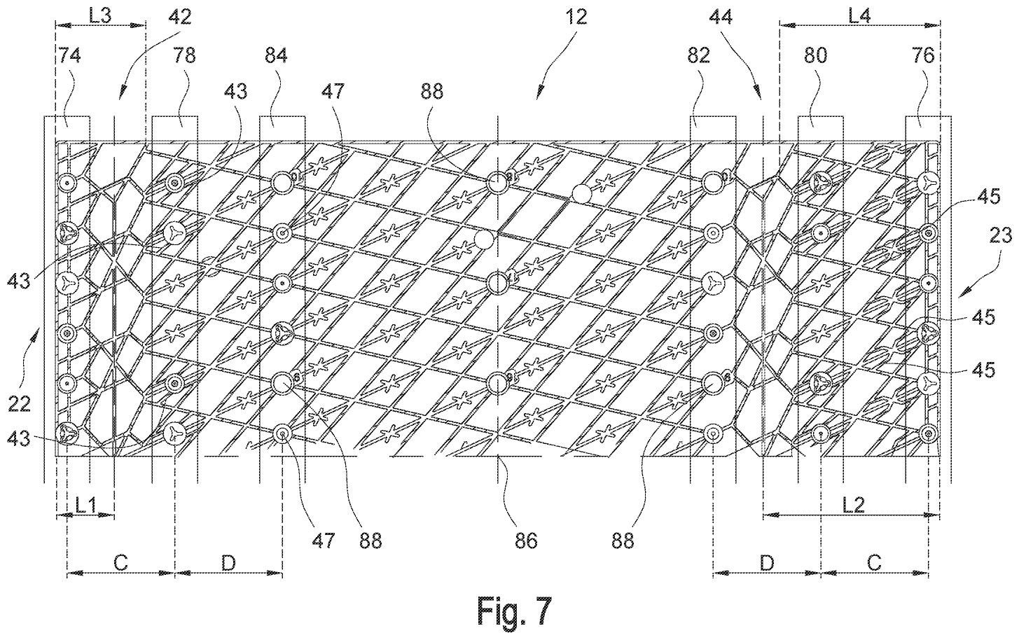

FIG. 7 is an enlarged sectional view of the grid mat, illustrating the arrangement of rows of pins and holes extending parallel to the longitudinal edges of the grid mat, with three such rows arranged at specific distances from one another towards each longitudinal edge.

FIG. 1 shows a schematic and exploded view of an installation element 10 in the form of a block consisting of several diagonally corrugated grid mats 12 (the grid structure is shown in FIGS. 2 to 5), wherein each grid mat is designed as shown as an example in FIGS. 2 and 3 in top plan view. Each grid mat 12 has an oblique corrugation consisting of elevations 14 or wave crests and depressions 16 or wave troughs, along which first grid struts 18 (see also FIGS. 2 to 5) extend. Adjacent elevations 14 and depressions 16 are connected to each other by slopes 20, whereby the installation element 10 is used, for example, according to the counterflow principle, such that the fluid to be treated (e.g. rising water vapor to be cooled) flows in the direction of arrow A (e.g. from bottom to top) through the installation element 10 and the working fluid (e.g. sprayed cooling water) drains in the opposite direction (see arrow B and consequently, in this case, from top to bottom) along the grid structures of the grid mats of the installation element. The grid mat 12 also has two substantially parallel, corrugated longitudinal edges, namely a first longitudinal edge 22 and a second longitudinal edge 23, as well as two transverse edges 24 which extend substantially transversely thereto and are also corrugated and parallel. The first grid struts 18 extend essentially between the two longitudinal edges 22, 23 and in part, namely in the corner areas, between a longitudinal edge and a transverse edge. The first grid struts 18 of the elevations 14 are located on the upper side 25 of the grid mat 12, while the first grid struts 18 of the depressions 16 are located on the lower side 26 of the grid mat 12.

As can be seen, for example, from FIGS. 2 to 5, the first grid struts 18 of adjacent elevations and depressions are connected along the slopes 20 by intersecting second and third grid struts 27, 28, which form first intersection points 30 with each other. These second and third grid struts 27, 28 also form second intersection points 32 with the first grid struts 18.

Between adjacent second intersection points 32 of the first grid struts 18 of both the elevations 14 and the depressions 16, the first grid struts have X-shaped projections 34, which are composed of two laterally projecting V-shaped projections 36, which are arranged opposite one another.

Some of the second crossing points 32 are provided with hole formations 38, while other second intersection points 32 have pin formations 40. The pin and hole designs are complementary and are described as examples in EP 3 690 378 A1.

As can be seen in particular from FIGS. 2 and 3, the first grid struts 18 are interrupted towards the two longitudinal edges 22. First interruption sections 42 interrupted towards the upper, i.e. first longitudinal edge 22 in FIGS. 2 and 3 are spaced therefrom by a first distance L1, whereas second interruption sections 44 of the first grid struts 18 interrupted towards the lower, i.e. second longitudinal edge 23 in FIGS. 2 and 3 are spaced therefrom by a second distance L2, with L2 being greater than L1.

Within the interruption sections 42, 44, which are preferably of equal length, the first grid struts of adjacent elevations 14 and/or adjacent depressions 16 and/or adjacent elevations and depressions are connected by sub-networks 46 comprising a plurality of intersecting and interconnected lower grid struts 48, 50, 52, 54, 56, 58, 60, 62. These individual sub-networks 46 are in turn interconnected by additional grid struts 64, 66, 68, 70 and by fourth grid struts 72, which extend parallel to the longitudinal edges 22. In FIGS. 4 and 5 it is shown that these sub-networks 46 extend approximately “midway” between the upper side 26 and the lower side 28 of the grid mat.

Adjacent to the first interruption portions 42, namely on the side facing away from the (upper) longitudinal edge 42, some of the first grid struts 18 have reinforcements on the upper and lower sides of the grid mat 12 in the form of parallel reinforcing grid struts 43 which extend between the nearest adjacent second intersection points 32. In a similar manner, reinforcing grid struts 45 are also arranged parallel to the first grid struts 18 at the (lower) longitudinal edge 23 adjacent to the second interruption sections 44, again between adjacent second intersection points 32 of the upper and lower sides of the grid mat 12. Furthermore, there are contact points on both sides of the first and second interruption sections 44, 46 in the form of the hole formations 38, the pin formations 40 and other plate-like support surfaces 47. All these details of the grid mat structure and its technical-mechanical stabilization functions are described below with reference to FIG. 6.

In FIG. 6, two grid mats 12 are shown lying next to each other with their upper sides pointing upwards. The arrows indicate that these two grid mats 12 are arranged with their upper sides lying on top of each other when assembled to form the installation package 10 (see FIG. 1). As a result, their respective elevations and depressions, i.e. their flow half-channels, intersect. It can be seen that the reinforcing grid struts 45 extend over the first interruption sections 42 (which applies to both, i.e. the upper and the lower longitudinal edge region) when both grid mats 12 lie against each other with their upper sides (by “folding over” the lower grid mat 12 and placing it on the upper grid mat 12). Due to the positioning of the pin and hole formations 38, 40, the two grid mats 12 connect in a substantially shear-resistant manner, which leads to the stabilization of the grid mats 12 within their areas weakened to a certain extent by the interruption sections 42, 44. The fact that the distance L1 of the first interruption sections 42 from the longitudinal edge 22 adjacent thereto is different (in this embodiment smaller) than the distance L2 of the second interruption sections 46 from their associated longitudinal edge 23 also contributes to this.

A further grid mat 12 is now placed with its lower side on the lower side of the upper grid mat 12, which is on top after the two grid mats 12 have been assembled, so that intersecting flow half-channels are again formed and the interruption sections of one grid mat 12 are spanned by continuous areas of first grid struts 18 of the other grid mat. Another grid mat 12 is now placed on the upper side of the grid mat 12 in the manner described in FIG. 6 by “folding it over”. This process is repeated until installation packages of the desired size (height) are assembled.

With reference to FIG. 7, it is described in more detail below where on, for example, the upper side 25 or the lower side 26 of the grid mat 12 the mutually complementary pin formations 40 and hole formations 38 (hereinafter referred to as pins and holes) are arranged, so that in the case of two adjacent grid mats 12 of an installation package 10, which lie against each other either with their upper sides 25 or with their lower sides 26, the respective first and second interruption sections 42, 44 are bridged by continuous sections of the first grid struts 18 and the grid mats 12 are mechanically connected/interlocked on both sides of the first and second interruption sections 42, 44 by interlocking pins and holes.

For this purpose, the grid mat 12 has a row 74 of alternating holes and pins on its first longitudinal edge 22. Such a row 76 with pins and holes is also present along the second longitudinal edge 23. Adjacent to the row 74 are the first interruption sections 42, on the sides of which facing away from the first longitudinal edge 22 there is again a row 78 with pins and holes. The distance between rows 74 and 78 is marked as C in FIG. 7. At this distance C from row 76 on the second longitudinal edge 23, a further row 80 with pins and holes is arranged parallel to it.

If a further grid mat 12 is now placed with its upper side on the grid mat 12 shown only partially in FIG. 7 (as shown in FIG. 6), the pins of row 74 engage in holes of row 76 and holes of row 74 receive pins of row 76. Accordingly, pins of row 80 engage in holes of row 78 and holes of row 80 pick up pins of row 78.

Between the two rows 76 and 80 there are continuous sections of first grid struts 18, which can also be reinforced (see the reinforcing grid struts 45). In these sections of the first grid struts 18 between the two rows 76 and 80, they span the first interruption sections 42. The interlocking (pin-and-hole joints) ensures that the grid mats 12 are connected in a shear-resistant manner.

The second interruption sections 44 are provided on both sides with rows of pins and holes, namely as row 80 (already mentioned above) and as row 82. The distance between these two rows is marked as D in FIG. 7 and can be equal to the distance C. A further row 84 with pins and holes extends parallel to row 78 and at a distance D from the same. The grid struts 18 extend continuously between these two rows 78 and 80. In these areas, they span the second interruption sections 44 when two grid mats 12 are in contact with their upper or lower sides. Here too, the interlocking (pin-and-hole joint) of the two grid mats 12 on both sides of the interruption sections 44 creates a shear-resistant bond.

The distance L4 of the ends of the second interruption sections 44 facing the second longitudinal edge 23 is, as shown in FIG. 7, greater than the distance L3 of the ends of the first interruption sections 42 facing away from the first longitudinal edge 22 from the first longitudinal edge 22.

The construction described stabilizes the grid mats 12 in the installation package 10. Their respective interruption sections 42, 44 are offset in relation to one pair of adjacent grid mats 12.

The pairs of rows 74 and 76, of rows 78 and 80 and of rows 82 and 84 are each arranged symmetrically to the central longitudinal axis 86 of the grid mat 12.

Several rings 88 are also positioned symmetrically to the central longitudinal axis 86 with holes enclosed by each of these. These rings 88 of a grid mat 12 are aligned with the rings 88 of the respective adjacent grid mats 12, thus forming channels with their aligned holes in the installation package 10, through which tension struts (not shown) can be inserted if necessary in order to give the installation package 10 further stability.

### LIST OF REFERENCE NUMERALS

10 installation element or package
12 grid mat
14 elevations
16 depressions
18 first grid struts
20 slopes
22 first longitudinal edge of a grid mat
23 second longitudinal edge of a grid mat
24 transversal edges of a grid mat
25 upper side of a grid mat
26 lower side of a grid mat
27 second grid struts
28 third grid struts
30 first intersection points
32 second intersection points
34 x-shaped protrusions
36 v-shaped protrusions
38 hole formations
40 pin formations
42 first interruption sections
43 reinforcing grid strut
44 second interruption sections
45 reinforcing grid strut
46 sub-networks
47 support surfaces
48 grid struts
50 grid struts
52 grid struts
54 grid struts
56 grid struts
58 grid struts
60 grid struts
62 grid struts
64 additional grid struts
66 additional grid struts
68 additional grid struts
70 additional grid struts
72 fourth grid struts
74 row with pins and holes
76 row with pins and holes
78 row with pins and holes
80 row with pins and holes
82 row with pins and holes
84 row with pins and holes
86 longitudinal centerline of the grid mat
88 rings with holes
L1 first distance
L2 second distance
L3 distance
L4 distance
A flow arrow for the useful fluid
A flow arrow for the working fluid

What is claimed is:

1. Corrugated grid mat of an installation element comprising a stack of a plurality of such grid mats, of a device for treating a useful fluid by means of a working fluid, in particular for humidifying and/or cleaning and/or cooling a useful fluid, in particular a gas, by means of a working fluid, in particular sprayed water, comprising
an upper side and a lower side,
a first longitudinal edge and a second longitudinal edge which extend essentially parallel to each other and are connected by two transverse edges which extend transversely to these longitudinal edges and are also essentially parallel to each other,
alternately adjacent depressions and elevations extending linearly at an angle not equal to 90° to both the longitudinal edges and the transverse edges with slopes connecting them,
the elevations being arranged on the upper side and the depressions on the lower side,
a rectilinear first grid strut extending along the elevations on the upper side and along the depressions on the lower side, and
the first grid struts of a respective elevation and the depression adjacent thereto being connected by intersecting second and third grid struts which extend along the slopes and form first intersection points with one another and second intersection points with the first grid struts on the upper side and on the lower side respectively,
wherein
each first grid strut extending up to the first longitudinal edge has a first interruption section, the center point of which has a first distance from the first longitudinal edge,
each first grid strut extending up to the second longitudinal edge has a second interruption section, the center point of which has a second distance from the second longitudinal edge,
the first distance being smaller than the second distance,
the first grid struts of in each case two adjacent elevations and/or in each case two adjacent depressions are connected on both sides of their first and second interruption sections in each case by further grid struts forming sub-networks with one another,
the sub-networks arranged next to one another along one of the longitudinal edges in each case being connected to one another by a fourth grid strut extending parallel to the respective longitudinal edge, which extends through the first or second interruption section and, for example, at the midpoint of the first or second interruption section, extends through the latter.

2. Corrugated grid mat according to claim 1, wherein the first and second interruption sections are of equal width.

3. Corrugated grid mat according to claim 1, wherein the sub-networks each lie within a central section located at a height between the upper side and the lower side and in that the fourth grid struts also extend at this height.

4. Corrugated grid mat according to claim 1, wherein the first grid struts between the second intersection points with the second and third grid struts each have laterally projecting rod-shaped projections extending at the level of the upper side and the lower side respectively.

5. Corrugated grid mat according to claim 4, wherein on both sides of a first grid strut a plurality of pairs is arranged each having two rod-shaped projections extending together in a V-shape, these four rod-shaped projections in turn forming X-shaped projections.

6. Corrugated grid mat according to claim 1, characterized by mutually complementary pin formations and hole formations distributed over the upper side and the lower side for connecting adjacent grid mats of the grid mat stack of an installation element in the case of intersecting elevations and depressions of adjacent grid mats of the grid mat stack, in that adjacent grid mats of the grid mat stack being arranged alternately with their upper sides and with their lower sides adjacent to one another, the first and the second interruption sections of a grid mat being arranged laterally offset with respect to their longitudinal edges relative to the second and first interruption sections of the respectively adjacent grid mat.

7. Corrugated grid mat according to claim 6, wherein the distance of the end of the second interruption section facing the second longitudinal edge from the second longitudinal edge is greater than the distance of the end of the first interruption section facing away from the first longitudinal edge from the first longitudinal edge.

8. Corrugated grid mat according to claim 6, wherein pin and/or hole formations are provided between the second interruption sections and the second longitudinal edge, spaced apart from one another in the direction orthogonal to the second longitudinal edge, which pin and/or hole formations correspond with respect to their respective spacing with pin and/or hole formations which are arranged on both sides of the first interruption section.

9. Corrugated grid mat according to claim 1, wherein at least two of the grid struts of each sub-network cross each other and the fourth grid strut extends through this crossing point.

10. Corrugated grid mat according to claim 9, wherein the fourth grid struts cross some of the grid struts of each sub-network.

11. Corrugated grid mat according to claim 9, wherein adjacent sub-networks are connected by some of their grid struts to the adjacent first grid struts and in particular to the first grid struts of adjacent elevations or adjacent depressions.

12. Installation element of a device for treating a useful fluid by means of a working fluid, in particular for humidifying and/or cleaning and/or cooling a useful fluid, in particular a gas, by means of a working fluid, in particular sprayed water, comprising
a stack of adjacent corrugated grid mats according to one of the preceding claims,
adjacent grid mats lying against one another at intersecting elevations and depressions, in each case adjacent grid mats being arranged alternately with their upper sides and their lower sides lying against one another, and the first and second interruption sections of a grid mat are arranged laterally offset with respect to the second and first interruption sections of the respectively adjacent grid mat.
